(19) United States
(12) Patent Application Publication
(10) Pub. No.: US 2006/0273990 A1
(43) Pub. Date: Dec. 7, 2006

(54) Plasma display device and driving method thereof

(76) Inventor: Byung-Gwon Cho, Chunan-si (KR)

Correspondence Address: CHRISTIE, PARKER & HALE, LLP, PO BOX 7068, PASADENA, CA, 91109-7068, US

(21) Appl. No.: 11/439,634

(22) Filed: May 23, 2006

(30) Foreign Application Priority Data
Jun. 1, 2005 (KR) 10-2005-0046709

(51) Int. Cl. G09G 3/28

(52) U.S. Cl. 345/67

(57) ABSTRACT

A plasma display device and a driving method. A driving waveform is applied while sustain electrodes are biased at a predetermined voltage. During an address period of a predetermined first subfield, a first scan pulse of a first voltage is applied to perform write addressing at a discharge cell to be selected at the first subfield, and during an address period of a predetermined second subfield, a second scan pulse having a second voltage that is greater than the first voltage is applied to perform erase addressing at a discharge cell that is not to be selected at the first subfield. A width of the second scan pulse is set to be less than that of the first scan pulse. Accordingly, a separate board for driving the sustain electrode may not be required and the address period can be shortened for a faster address operation.

### CROSS-REFERENCE TO RELATED APPLICATION

This application claims priority to and the benefit of Korean Patent Application No. 10-2005-0046709 filed in the Korean Intellectual Property Office on Jun. 1, 2005, the entire content of which is incorporated herein by reference.

### BACKGROUND OF THE INVENTION

(a) Field of the Invention

The present invention relates to a plasma display panel and a driving method thereof.

(b) Description of the Related Art

A plasma display panel (PDP) is a flat panel display that uses plasma generated by electric discharge in a gas to display characters or images. It includes, depending on its size, more than several hundreds of thousands to millions of pixels arranged in a matrix pattern. Such a PDP is classified as a direct current (DC) type or an alternating current (AC) type according to its discharge cell structure and the waveform of the driving voltage applied thereto.

The DC PDP has electrodes exposed to a discharge space, and accordingly, it allows a DC to flow through the discharge space while a voltage is being applied. Therefore, such a DC PDP requires a resistance for limiting the current. Addition of a resistance to the PDP is problematic. On the other hand, the AC PDP has electrodes covered with a dielectric layer that form a capacitor to limit the current and protect the electrodes from the impact of ions during discharge.

One frame for driving the AC PDP is divided into a plurality of subfields, and each subfield includes a reset period, an address period, and a sustain period.

The reset period is for initializing the status of each discharge cell so as to facilitate an addressing operation on the discharge cell. The address period is for selecting turn-on/turn-off cells and accumulating wall charges to the turn-on cells (i.e., addressed cells). The sustain period is for causing and sustaining a discharge for displaying an image on the addressed cells.

In order to perform the above operation, sustain pulses are alternately applied to the scan electrodes and the sustain electrodes during the sustain period, and reset waveforms and scan waveforms are applied to the scan electrodes during the reset period and the address period. Therefore, a scan driving board for driving the scan electrodes and a sustain driving board for driving the sustain electrodes are separately needed. In this case, a problem of mounting the driving boards on a chassis base may arise, and the cost increases because of the separate driving boards.

Therefore, schemes for combining the two driving boards into a single combined board have been proposed that include coupling the scan electrodes to the combined board and extending the sustain electrodes to reach the combined board. However, when the two driving boards are combined as such, the impedance component formed at the extended sustain electrodes is increased.

In the conventional driving methods, a predetermined time is needed to accumulate the wall charges at the turn-on discharge cell. The address period is for generating an address discharge at the addressed cells so that the required wall charges are accumulated in the addressed cells. Recently, as plasma display devices have become larger, the number of scan electrode lines has increased. Accordingly, the conventional overall duration of the address period and the conventional address discharge are insufficient to accumulate the required wall charges in the addressed cells.

### SUMMARY OF THE INVENTION

The present invention provides a plasma display device and a driving method thereof using a single combined board for driving scan and sustain electrodes. In addition, the present invention provides a method for driving a plasma display panel with a driving waveform for decreasing an address period that is appropriate for a single combined board.

An exemplary plasma display device according to an embodiment of the present invention includes a plurality of first electrodes, a plurality of second electrodes, and a plurality of third electrodes formed crossing a common direction of the first electrodes and the second electrodes. The plasma display device includes a plasma display panel that is driven during frames of time, each frame being divided into subfields that are each in turn being assigned a subfield weight. An exemplary driving method for this plasma display device keeps the first electrodes at a first voltage that may be a ground voltage during all of the subfields. During an address period of a first subfield, the driving method selects a discharge cell to be turned on in the first subfield by applying a first scan pulse having a second voltage to the second electrodes of the discharge cell. During a sustain period of the first subfield, the method alternately applies a third voltage and a fourth voltage that is less than the third voltage to the second electrodes. During an address period of the second subfield, the method selects a discharge cell to be turned off in a second subfield by applying a second scan pulse of a fifth voltage that is greater than the second voltage to the second electrodes. During a sustain period of the second subfield, the method alternately applies a sixth voltage and a seventh voltage that is greater than the sixth voltage to the second electrodes.

In a further embodiment, the second scan pulse may be narrower than the first scan pulse.

An exemplary plasma display device according to an embodiment of the present invention includes a plasma display panel and a chassis base facing the plasma display panel.

The plasma display panel has a plurality of first electrodes, a plurality of second electrodes, and a plurality of third electrodes crossing a common direction of the first and second electrodes. The chassis base includes a driving board for applying a driving waveform to the second and third electrodes to display an image on the plasma display panel and for biasing the first electrode to a first voltage while the image is displayed. The driving board selects a discharge cell to be turned on during a first subfield by applying a first scan pulse having a first width to the second electrodes during an address period of the first subfield, and selects a discharge cell to be turned off during a second subfield by applying a second scan pulse having a second width that is less than the first width to the second electrodes during an address period of the second subfield. In a further embodiment, a voltage of the second scan pulse may be greater than that of the first scan pulse.

### BRIEF DESCRIPTION OF THE DRAWINGS

FIG. 1 shows an exploded perspective view of a plasma display device according to an exemplary embodiment of the present invention.

FIG. 2 shows a schematic view of a plasma display panel according to an exemplary embodiment of the present invention.

FIG. 3 schematically shows a plan view of a chassis base according to an exemplary embodiment of the present invention.

FIG. 4 shows a diagram for representing a driving waveform according to a first exemplary embodiment of the present invention.

FIG. 5 shows a diagram for representing a wall charge condition of a cell in which a strong discharge is generated during a reset period.

FIG. 6 shows a diagram for representing a driving waveform according to a second exemplary embodiment of the present invention.

### DETAILED DESCRIPTION OF THE EMBODIMENTS

The wall charges being described in the present invention are charges formed on a wall (e.g., a dielectric layer) close to each electrode of a discharge cell. The wall charges will be described as being “formed” or “accumulated” on the electrode, although the wall charges do not actually touch the electrodes. Further, a wall voltage is a potential difference formed on the wall of the discharge cell by the wall charges.

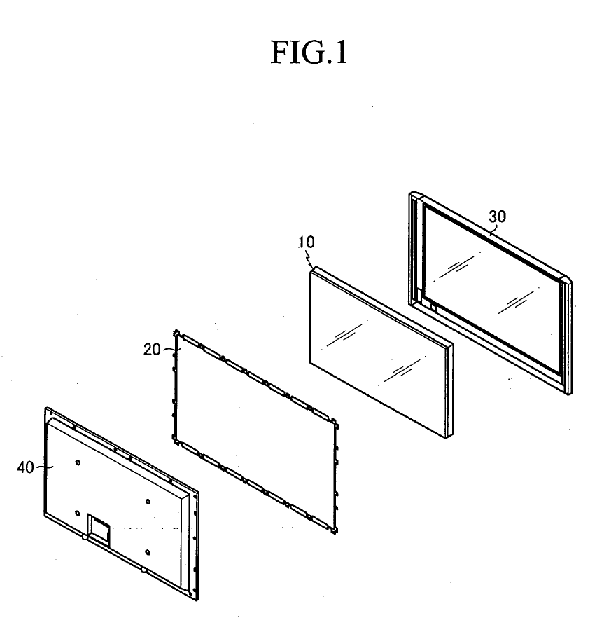

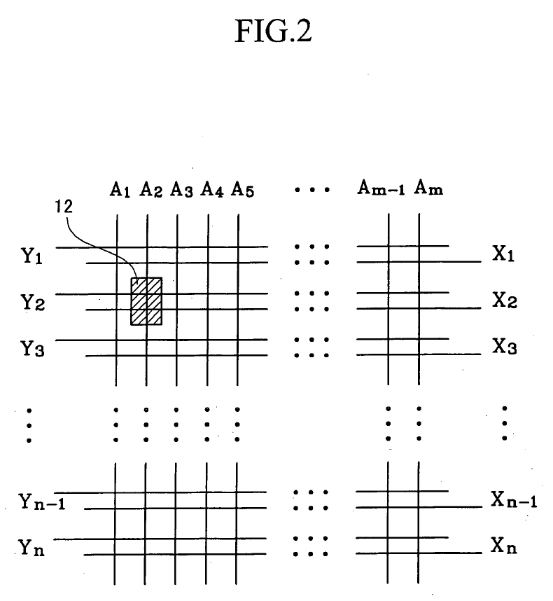

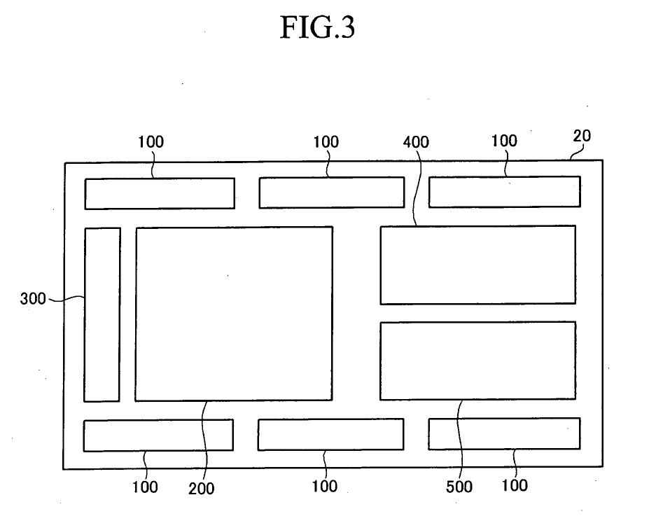

A schematic configuration of a plasma display device according to an embodiment of the present invention is described in detail with reference to FIG. 1, FIG. 2, and FIG. 3.

As shown in FIG. 1, the plasma display device includes a plasma display panel 10, a chassis base 20, a front case 30, and a rear case 40. The chassis base 20 is combined with or coupled to a side of the plasma display panel 10 that is opposite to an image display side of the plasma display panel 10. The front case 30 is located to the front of the plasma display panel 10 and the rear case 40 is located to the rear of the chassis base 20. The front and rear cases 30, 40 are combined with or coupled to respectively the chassis base 20 and the plasma display panel 10 to form a plasma display device.

As shown in FIG. 2, the plasma display panel 10 includes a plurality of address electrodes A1 to Am extending in a column direction, and a plurality of scan electrodes Y1 to Yn and a plurality of sustain electrodes X1 to Xn extending in a row direction. The sustain electrodes X1 to Xn are formed to correspond to the scan electrodes Y1 to Yn, respectively. Ends of the sustain electrodes X1 to Xn are connected in common. The plasma display panel 10 includes a substrate having the sustain and scan electrodes X1 to Xn and Y1 to Yn formed thereon, and another substrate having the address electrodes A1 to Am formed thereon. The two substrates are located to face each other while interposing a discharge space such that the address electrodes A1 to Am perpendicularly cross a common direction of both the scan electrodes Y1 to Yn and the sustain electrodes X1 to Xn. The discharge spaces formed where the address electrode A1 to Am cross the sustain and scan electrodes X1 to Xn and Y1 to Yn form discharge cells 12.

As shown in FIG. 3, driving boards 100, 200, 300, 400, 500 for driving the plasma display panel 10 are formed on the chassis base 20. An address buffer board 100 may be formed as a single board or a combination of a plurality of boards on the chassis base 20. FIG. 3 exemplarily illustrates that the address buffer boards 100 are formed on the top and bottom areas of the chassis base 20. However, it is notable that such a configuration relates to a dual driving scheme. That is, in a single driving scheme, the address buffer board 100 is formed on either the top or the bottom area of the chassis base 20. The address buffer board 100 receives an address driving control signal from an image processing and controlling board 400 and applies a voltage for selecting a turn-on cell to the address electrodes A1 to Am.

A scan driving board 200 is provided to the left on the chassis base 20 and is coupled to the scan electrodes Y1 to Yn through a scan buffer board 300. The sustain electrodes X1 to Xn are biased at a predetermined voltage. During an address period, the scan buffer board 300 applies a voltage for sequentially selecting scan electrodes Y1 to Yn to the scan electrode Y1 to Yn. The scan driving board 200 receives a driving signal from the image processing and controlling board 400 and applies the driving voltage to the scan electrodes Y1 to Yn. While the scan driving board 200 and the scan buffer board 300 are shown to the left on the chassis base 20 in FIG. 3, they may alternatively be provided to the right or at some other equivalent location on the chassis base 20. In addition, the scan buffer board 300 and the scan driving board 200 may be integrally formed as one board.

While externally receiving an image signal, the image processing and controlling board 400 generates a control signal for driving the address electrodes A1 to Am and a control signal for driving the scan and sustain electrodes Y1 to Yn and X1 to Xn, and then applies the control signals to the address driving boards 100 and the scan driving board 200. A power supply board 500 supplies power for driving the plasma display device. The image processing and controlling board 400 and the power supply board 500 may be located on a central area of the chassis base 20.

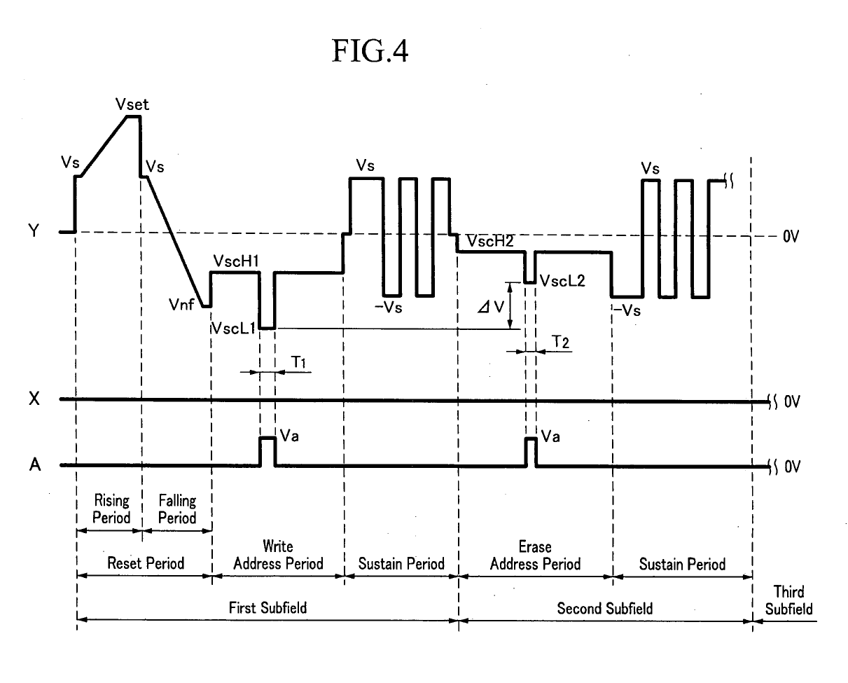

Driving waveforms of the plasma display panel according to a first exemplary embodiment of the present invention will be described with reference to FIG. 4.

FIG. 4 shows a diagram for representing a driving waveform according to a first exemplary embodiment of the present invention. Hereinafter, for convenience of description, a driving waveform applied to a single sustain electrode (hereinafter, referred to as “X electrode”), a single scan electrode (hereinafter, referred to as “Y electrode”), and a single address electrode (hereinafter, referred to as “A electrode”) for forming only one discharge cell will be described.

In the driving waveform shown in FIG. 4, the Y electrode receives a voltage from the scan driving board 200 and the scan buffer board 300, and the A electrode receives a voltage from the address buffer board 100. The X electrode is biased at a reference voltage (represented as a ground voltage in FIG. 4), and accordingly the voltage applied to the X electrode will not be described in further detail.

In the driving methods according to the exemplary embodiments of the present invention, one field is divided into a plurality of subfields. For convenience of description, FIG. 4 illustrates only driving waveforms applied during the first and second subfields among the plurality of subfields. In addition, a driving waveform that is the same as the driving waveform applied during the first subfield or the second subfield may be applied during the rest of the subfields. The first subfield includes a reset period, a write address period, and a sustain period, and the second subfield includes an erase address period and a sustain period. The write address period is referred to as an address period of the first subfield, during which an address voltage Va is applied to a discharge cell to be turned on during the first subfield and wall charges are accumulated at the turn-on cell. The erase address period is referred to as an address period of the second subfield, during which the address voltage Va is applied to a discharge cell to be turned off during the second subfield and wall charges are erased at the turn-off cell.

The reset period of the first subfield includes a rising period and a falling period. During the rising period of the reset period, the voltage of the Y electrode is gradually increased from a voltage of Vs to a voltage of Vset while the A electrode is maintained at the reference voltage (represented as 0V in FIG. 4). FIG. 4 illustrates that the voltage of the Y electrode increases from Vs to Vset in a ramp style. A weak discharge is generated between the Y and X electrodes and between the Y and A electrodes while the voltage of the Y electrode is increased, and negative (−) wall charges are formed on the Y electrode and positive (+) wall charges are formed on the X and A electrodes. In addition, in the case that the voltage of the Y electrode gradually changes as shown in FIG. 4, a weak discharge is caused in the cell, and accordingly wall charges are formed such that a sum of the externally applied voltage and the wall voltage may be maintained at a discharge firing voltage.

Because every cell has to be initialized during the reset period, the voltage Vset is a voltage that is high enough to fire a discharge. Generally, the voltage Vs is equal to or greater than the voltage applied to the Y electrode during the sustain period, and is less than a voltage required for firing a discharge between the Y and X electrodes.

During the falling period of the reset period, the voltage of the Y electrode is gradually reduced from the voltage Vs to a voltage Vnf while the voltage of the A electrode is maintained at the reference voltage. Then, a weak discharge is generated between the Y and X electrodes and between the Y and A electrodes while the voltage of the Y electrode is reduced, and accordingly the negative (−) wall charges formed on the Y electrode and the positive (+) wall charges formed on the X and A electrodes are eliminated. The voltage of Vnf is set to be close to a discharge firing voltage between the Y and X electrodes. Then a wall voltage (i.e., a potential difference) between the Y and X electrodes reaches approximately 0V, and therefore a cell that is not address discharged in the address period may be prevented from misfiring in the sustain period. The wall voltage between the Y and A electrodes is determined by level of the voltage Vnf because the voltage of the A electrode is maintained at the reference voltage.

Subsequently, during the write address period for selecting the turn-on cells of the first subfield, a scan pulse of a voltage VscL1 and an address pulse of the voltage Va are respectively applied to the Y and A electrodes of the turn-on cell. A non-selected Y electrode is biased at a voltage of VscH1 which is higher than the voltage of VscL1, and the reference voltage is applied to the A electrode of the cells that are to remain turned off. The scan buffer board 300 selects a Y electrode to receive the scan pulse of VscL1, from among the Y electrodes Y1 to Yn. For example, in the single driving method, the Y electrodes may be selected in an order of arrangement of the Y electrodes, that extend along row directions, down the column direction. When a Y electrode is selected, the address buffer board 100 selects cells to be turned on among the cells formed along the selected Y electrode. That is, the address buffer board 100 selects A electrodes to which the address pulse of the voltage of Va is applied among the A electrodes A1 to Am.

In more detail, the scan pulse of the voltage VscL1 is first applied to the scan electrode in a first row (Y1 shown in FIG. 2), and at the same time the address pulse of the voltage Va is applied to the A electrode on the cells to be turned on in the first row. Then a discharge is generated between the Y electrode in the first row and the A electrodes receiving the voltage Va, and accordingly positive (+) wall charges are formed on the Y electrode and negative (−) wall charges are formed on the A and X electrodes. As a result, a wall voltage (Vwxy) is formed between the X and Y electrodes such that a potential of the Y electrode becomes higher than the potential of the X electrode. Subsequently, the address pulse of the voltage Va is applied to the A electrode on cells to be turned on in a second row while the scan voltage of the voltage VscL1 is applied to the Y electrode in the second row (Y2 shown in FIG. 2). Then, the address discharge is generated in the cells crossed by the A electrodes receiving the voltage Va and the Y electrode in the second row, and accordingly wall charges are formed in such cells, in a like manner as described above. Regarding Y electrodes in other rows, wall charges are formed in cells to be turned on in the same manner described above, i.e., by applying the address pulse of the voltage Va to A electrodes of cells to be turned on while sequentially applying the scan pulse of the voltage VscL1 to the Y electrodes.

Generally, the voltage VscL1 is set to be equal to or less than the voltage Vnf, and the voltage Va is set to be greater than the reference voltage during a write address period.

Hereinafter, the reason why address discharge occurs at a discharge cell selected by applying the voltage Va while the voltage VscL1 is equal to the voltage Vnf will be described. When the voltage Vnf is applied in the reset period, a sum of the wall voltage between the A and Y electrodes and the external voltage Vnf between the A and Y electrodes reaches the discharge firing voltage Vfay between the A and Y electrodes. For example, when the 0V is applied to the A electrode and the voltage VscL1 (=Vnf) is applied to the Y electrode during the address period, the voltage Vfay is formed between the A and Y electrodes, and accordingly generation of the discharge may be expected. However, in this case, the discharge is not actually generated because a discharge delay is greater than width T1 of the scan pulse and the address pulse. However, if the voltage Va is applied to the A electrode and the voltage VscL1(=Vnf) is applied to the Y electrode, a voltage greater than the voltage Vfay is formed between the A and Y electrodes, and accordingly the discharge delay time is reduced to less than the width T1 of the scan pulse. Therefore, the discharge may be generated. Generation of the address discharge may be facilitated by setting the voltage VscL1 to be less than the voltage Vnf.

During the write address period of the first subfield, the width T1 of the scan pulse is set appropriately to form the wall charges on the addressed discharge cell. That is, when the scan pulse of the voltage VscL1 and the address pulse of the voltage Va are respectively delivered to the Y and A electrodes so that address discharge is generated, it takes time to form positive (+) wall charges on the Y electrode and negative (−) wall charges on the X electrode and the A electrode by accumulation of the charges generated by the address discharge. When the width T1 of the scan pulse is less than a predetermined duration, wall charges are not accumulated by the address discharge and they disappear. When the width T1 of the scan pulse is much longer than a predetermined duration, a time allocated to the sustain period is reduced and thus the brightness may be reduced because the address period is extended. Therefore, the width T1 of the scan pulse is set to be sufficiently long to form the wall charges on the addressed discharge cell and not longer. In addition, the width of the address pulse of the voltage Va is set to be equal to the width T1 of the scan pulse.

In the discharge cells that have experienced an address discharge during the write address period, the wall voltage Vwxy is formed such that the potential of the Y electrode is higher than the potential of the X electrode. Therefore, subsequently, during the sustain period of the first subfield, a sustain discharge is triggered between the Y and X electrodes by first applying a pulse of the voltage Vs to the Y electrode.

The discharge cells having undergone a sustain discharge are cells selected by respectively applying the voltages VscL1 and Va to the Y and A electrodes in the write address period. Accordingly, a sustain discharge may not occur at a cell not selected in the write address period because wall charges are insufficient. In this case, the voltage Vs is set such that it is lower than the discharge firing voltage Vfxy and a voltage value Vs+Vwxy is higher than the voltage Vfxy. Therefore, during the sustain discharge, positive (+) wall charges are formed on the Y electrode and negative (−) wall charges are formed on the X and A electrodes, and the wall voltage Vwxy is formed such that the potential of the Y electrode is higher than the potential of the X electrode.

Then, a sustain discharge pulse of a negative voltage −Vs is applied to the Y electrode to fire a subsequent sustain discharge. Therefore, positive (+) wall charges are formed on the Y electrode and negative (−) wall charges are formed on the X and A electrodes, such that another sustain discharge may be fired by applying the voltage Vs to the Y electrode. Subsequently, the process of applying the sustain pulse of voltages Vs and −Vs to the scan electrode Y is repeated by a number corresponding to a weight value of a corresponding subfield.

A subsequent second subfield includes an erase address period and a sustain period. The erase address period of the second subfield occurs without a preceding reset period and directly follows the sustain period of the first subfield. In the erase address period of the second subfield, a scan pulse of a voltage VscL2 and an address pulse of a voltage Va are applied to respectively the Y electrode and the A electrode of a discharge cell to be turned off in the second subfield among the cells having undergone sustain discharge in the first subfield. In addition, the non-selected Y electrodes are biased at a voltage VscH2 that is greater than the voltage VscL2. An A electrode of a cell to be turned on in the second subfield receives the reference voltage. That is, during the erase address period, address discharge is generated at a discharge cell to be turned off during the second subfield among the cells having undergone a sustain discharge during the first subfield so that the wall charges formed during the sustain period of the first subfield are erased. In order to perform such operations, the scan buffer board 300 selects a Y electrode to receive a scan pulse of the voltage VscL2 among the Y electrodes Y1 to Yn, and the address buffer board 100 selects an address electrode to be applied with an address pulse of the voltage Va among the A electrodes A1 to Am. The selected Y electrode and the selected A electrode define the selected discharge cell.

For example, the scan pulse of the voltage of VscL2 may be first applied to the scan electrode (Y1 shown in FIG. 2) in the first row. At the same time, the address pulse of the voltage Va is applied to an A electrode in a cell along the first row to be turned off during the second subfield. Then a discharge is generated between the Y electrode of the first row receiving the scan pulse and the A electrode receiving the address pulse. Accordingly, wall charges formed on the turn-on discharge cell are erased. Because the last sustain pulse of the voltage Vs is applied to the Y electrode during the sustain period of the first subfield, the negative (−) wall charges are formed on the Y electrode and the positive (+) wall charges are formed on the X electrode and the A electrode. Then, because the voltage Vwya is formed such that the potential of the Y electrode becomes lower than the potential of the A electrode, the voltage VscL2 is applied to the Y electrode and the voltage Va is applied to the A electrode to generate an address discharge. At this time, the erasing of the wall charges due to the address discharge is related to a level and a pulse width T2 of the voltage VscL2. The level and the pulse width T2 of the voltage VscL2 will be described. The wall discharge formed by the sustain discharge of the first subfield is erased at the discharge cell receiving the voltage VscL2 and the voltage Va that is located along the Y electrode of the first row. Next, an address pulse of the voltage Va is applied to an A electrode of the discharge cell to be turned off during the second subfield among the discharge cells formed along the second row while a scan pulse of the voltage VscL2 is applied to the Y electrode of the second row (Y2 of FIG. 2). As described above, the address discharge occurs and the wall charges are erased at the discharge cell formed by the Y electrode of the second row and the A electrode receiving the voltage Va. Likewise, the scan pulse of the voltage VscL2 is sequentially applied to the Y electrodes of the rest of the rows and the address pulse of the voltage Va is applied to the A electrodes placed at the turn-off cells so that the wall discharge is erased in those cells.

A level and a width of the sustain pulse of the voltage VscL2 applied during the erase address period of the second subfield, that is sufficient to erase the wall charges formed by the sustain discharge during the first subfield, is now described.

First, the level of the voltage VscL2 must be set to be higher than the voltage VscL1 applied during the write address period of the first subfield (note ΔV=VscL2−VscL1 of FIG. 4). If the level of the voltage VscL2 is below the level of the voltage VscL1, the application of the voltage VscL2 may cause misfiring at a discharge cell having undergone a sustain discharge during the first subfield. Therefore, the voltage VscL2 is set to be greater than the voltage VscL1. As shown in FIG. 4, in the exemplary embodiment being described, VscL1 and VscL2 are both negative voltages. As a result, the VscL2 being higher than VscL1 indicates that VscL2 is a less negative voltage and has a smaller absolute value. In addition, the discharge is generated when the voltages VscL2 and Va are applied to a discharge cell to be turned off among discharge cells having undergone sustain discharge in the first subfield. Therefore, the voltage VscL2 must be set such that a sum of the wall voltage Vwya and the voltage Va-VscL2 exceeds the discharge firing voltage Vfxy. In addition, as described below, because misfiring may occur when the voltage VscL2 is less than the voltage −Vs, the voltage VscL2 must be set to be greater than the voltage −Vs.

Further, in the exemplary embodiment shown, the width T2 of the scan pulse of the voltage VscL2 is less than the width T1 of the scan pulse of the voltage VscL1 (T2<T1). This is because erasing the wall charges formed by the sustain discharge in the first subfield by applying the voltages VscL2 and Va during the erase address period of the second subfield must not cause accumulation of further wall charges in the discharge cell. That is, the goal of the erase address period is erasing the existing wall charges without allowing more wall charges to form as a result of the erasure process. Therefore, the duration of T2 is kept short so as not to allow time for wall charges formed by the address discharge to accumulate.

As shown in FIG. 4, in the sustain period of the first subfield, the last sustain pulse is applied to the Y electrode. At this time, the negative (−) wall charges are formed on the Y electrode and the positive (+) wall charges are formed on the X and A electrodes. Therefore, as a result of wall charges formed, the Y electrode is at a lower potential than the A electrode. This may cause misfiring at the non-selected discharge cells if the voltage VscL2 is below the voltage −Vs. To prevent such misfiring, the level of the voltage VscL2 is set above the level of the voltage −Vs.

As described above, the discharge cell that is selected and has undergone an address discharge during the erase address period of the second subfield will be turned off in the sustain period of the second subfield because its wall charges have been eliminated. Some of the discharge cells, among the discharge cells having undergone a sustain discharge during the first subfield, are not selected during the erase address period of the second subfield. The discharge cells not selected, retain their wall charges after the erase address period of the second subfield. So, the wall charge state after the sustain period of the first subfield is maintained at the discharge cells not selected in the erase address period of the second subfield among the discharge cells having undergone a sustain discharge during the first subfield. As shown in FIG. 4, the pulse of the voltage Vs is applied to the Y electrode in the final stage of the sustain period of the first subfield. As a result, negative (−) wall charges are formed on the Y electrode and positive (+) wall charges are formed on the X and A electrodes. Therefore, as shown in FIG. 4, during the sustain period of the second subfield, first the pulse of the voltage −Vs is applied to the Y electrode. Consequently, a sustain discharge occurs at the discharge cells not selected during the erase address period of the second subfield among the discharge cells having undergone a sustain discharge during the first subfield. A stable sustain discharge may not occur at the discharge cell to be turned on during the second subfield among the discharge cells having undergone a sustain discharge during the first subfield. This is due to the fact that wall charges and priming particles within the discharge cell may decrease during the long interval between the sustain periods of the first and second subfields. However, a stable sustain discharge is more likely to occur when the pulse of the voltage −Vs first applied in the sustain period of the second subfield is wider than other sustain pulses following the first pulse.

Subsequently, the process of alternately applying the sustain discharge pulses of voltages Vs and −Vs voltage to the scan electrode Y is repeated by a number of times corresponding to the weight assigned to the subfield.

According to the exemplary embodiments of the present invention, the reset, the address, and the sustain discharge operations can be performed by the driving waveform applied to the Y electrode while the X electrode is biased at a reference voltage. That is, a single integrated board for driving both electrodes is realized, and the cost is reduced. A separate board for driving the X electrode is not required only if the X electrode is biased at a reference voltage. In the first exemplary embodiment of the present invention, the address operation may be performed also by an erasing process during an erase address period of a predetermined subfield. Therefore, the width T2 of the scan pulse used for erasing some of the previously addressed cells can be shortened compared to the width T1 of the scan pulse previously used for addressing during the write address period of the prior subfield. As a result of the shorter erase address period, the address operation is performed faster.

As shown in FIG. 4, according to the first exemplary embodiment, a final voltage applied to the Y electrode in the falling period of the reset period of the first subfield is set to be the voltage Vnf, and the final voltage Vnf may be near the discharge firing voltage between the Y and X electrodes. However, a wall potential of the Y electrode with respect to the A electrode may be set to be a positive voltage at the final voltage Vnf of the falling period because the discharge firing voltage Vfay between the Y and A electrodes is generally less than the discharge firing voltage Vfxy between the Y and X electrodes. The reset period of a subsequent subfield begins while the above wall charge state is maintained in the cells, because sustain discharge is not generated in cells that have not undergone a write address discharge in the first subfield and have not been selected during that subfield.

In the above state, the potential difference between the Y electrode with respect to the X electrode is greater than the potential difference between the Y and A electrodes. Therefore, when the voltage of the Y electrode is increased in the rising period of the reset period, the voltage difference between the X and Y electrodes may exceed the discharge firing voltage Vfxy in a predetermined time after the voltage difference between the A and Y electrodes exceeds the discharge firing voltage Vfay.

The Y electrode operates as a positive electrode and the A electrode and X electrode operate as negative electrodes because a high voltage is applied to the Y electrode in the rising period of the reset period. The discharge in the cell is determined by the amount of second electrons emitted from a negative electrode when positive ions collide against the negative electrode, which is referred to as a “y process.”

Generally, in the plasma display panel, the A electrode is covered with a phosphor for color representation, and the X and Y electrodes are covered with a dielectric layer of MgO for increasing sustain-discharge performance. The secondary electron emission coefficient of the dielectric layer consisting of MgO is high, and the secondary electron emission coefficient of the phosphor layer is low. When the voltage difference between the A and Y electrodes exceeds the discharge firing voltage Vfay, the A electrode operates as the negative electrode. However, because the A electrode is covered with the phosphor, the discharge may be delayed between the A and Y electrodes during the rising period. Due to the discharge delay, the voltage difference between the A and Y electrodes is greater than the discharge firing voltage at the time that the discharge is actually generated between the A and Y electrodes. Therefore, instead of a weak discharge, a strong discharge can be generated between the A and Y electrodes by such a high voltage. In short, the high voltage difference caused by the discharge delay induces a strong discharge, between the A and Y electrodes during the rising period of the reset period.

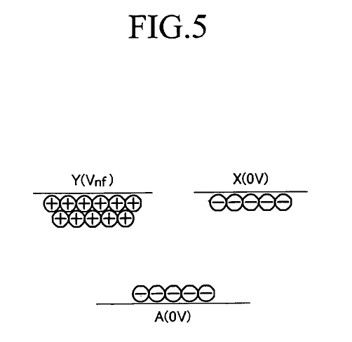

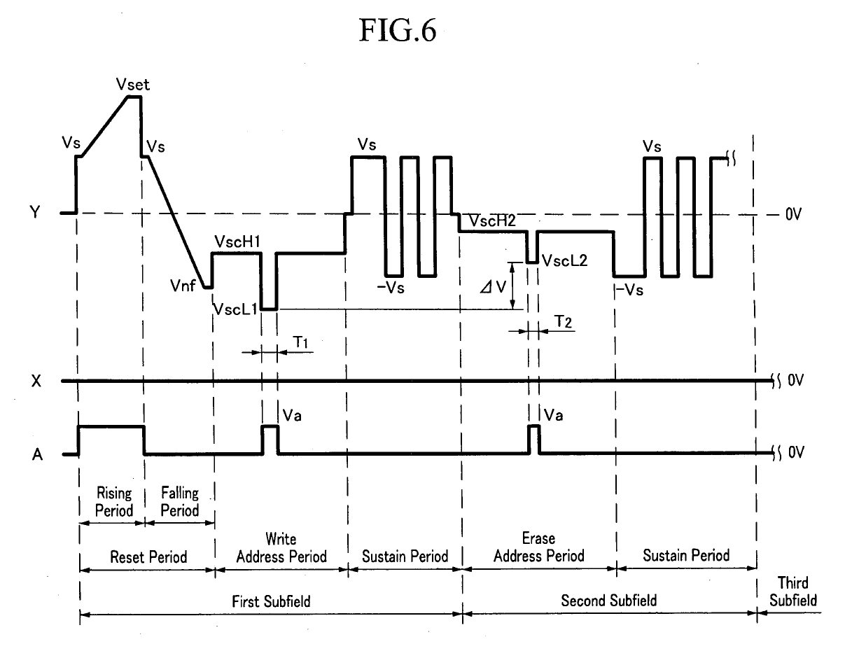

FIG. 5 shows the state of wall charges after the falling period of the reset period. A strong discharge may be generated by the wall charges and the priming particles during the falling period and the wall charges may not be properly eliminated between the X and Y electrodes, as shown in FIG. 5. In this case, a high wall voltage is formed between the X and Y electrodes in the cell when the reset period ends. Therefore, during the sustain period, misfiring discharge may occur between the X and Y electrodes by the high wall voltage in the cells that have not been addressed during the address period. An exemplary embodiment for preventing this misfiring discharge will be described with reference to FIG. 6.

FIG. 6 shows a driving waveform of the plasma display panel according to the second exemplary embodiment of the present invention. While the driving waveform according to the second exemplary embodiment of the present invention is similar to the driving waveform according to the first exemplary embodiment, the A electrode is biased at a predetermined voltage during the rising period of the reset period in the second exemplary embodiment.

In more detail, the voltage of the Y electrode is gradually increased from the voltage Vs to the voltage Vset while the A electrode is biased at a predetermined voltage higher than the reference voltage during the rising period of the reset period. It is not necessary to provide an additional bias voltage to be applied to the A electrode if the voltage Va is used as the bias voltage of the A electrode. When the voltage of the Y electrode is increased while the A electrode is biased at the voltage Va, the voltage difference between the A and Y electrodes is less than the difference between the two voltages in the first exemplary embodiment. Therefore, the voltage difference between the X and Y electrodes exceeds the discharge firing voltage before the voltage difference between the A and Y electrodes exceeds the discharge firing voltage. The voltage difference between the A and Y electrodes exceeds the discharge firing voltage after a weak discharge has already been generated between the X and Y electrodes and the priming particles have begun to form by the weak discharge. The delay in the discharge between the A and Y electrodes is reduced by the priming particles. Accordingly, a weak discharge is generated instead of the strong discharge, and the wall charges are properly formed. In addition, the misfiring discharge may be prevented because the strong discharge is not generated in the falling period of the reset period.

While the A electrode is biased at the predetermined voltage during the entire rising period in FIG. 6, the A electrode may be biased at the predetermined voltage only during an early stage of the rising period according to the third exemplary embodiment (not shown). When the A electrode is biased at the predetermined voltage in the early stage of the rising period, the voltage difference between the A and Y electrodes does not exceed the discharge firing voltage before the voltage difference between the X and Y electrodes exceeds the discharge firing voltage. Therefore, strong discharge is not generated in the rising period. The voltage of the A electrode may then be set to be the reference voltage after the weak discharge is generated between the A and Y electrodes.

In an alternative embodiment, the voltage of the A electrode may be gradually increased. When the voltages of the Y and A electrodes are increased together, the weak discharge is generated between the X and Y electrodes before the weak discharge generates between the A and Y electrodes because the voltage difference between the A and Y electrodes is further reduced to less than the voltage difference when the A electrode is biased at the reference voltage. In this alternative, the voltage of the A electrode may be increased during a part or all of the rising period.

Also, the A electrode may be floated instead of increasing the voltage of the A electrode. When the voltage of Y electrode is increased and the A electrode is floated, the voltage of the A electrode is increased as the voltage of the Y electrode is increased because a capacitance is formed between the A and Y electrodes, and therefore the operation shown in FIG. 6 is performed. The voltage of the A electrode may be floated during a portion or the entire duration of the rising period.

According to the exemplary embodiments of the present invention, a separate and extra board for driving the sustain electrode is not required because the sustain electrode is biased at a constant voltage and the driving waveform is applied to the scan electrode. So, a single integrated board for driving both electrodes may be realized, and the cost is reduced.

In addition, an erase address operation is performed during the address period of some of the subfields that requires a scan pulse of lower amplitude and shorter duration so that the width T2 of the scan pulse can be further reduced. Consequently, the address period can be shortened resulting in a faster address operation.

Further, misfiring can be prevented by biasing the address electrode at a voltage that is greater than the reference voltage during part or all of the rising period of the reset period.

While this invention has been described in connection with certain exemplary embodiments, it is to be understood that the invention is not limited to the embodiments described, but, on the contrary, is intended to cover various modifications and equivalent arrangements included within the spirit and scope of the appended claims and their equivalents.

What is claimed is:

1. A driving method of a plasma display device having a plurality of first electrodes, a plurality of second electrodes, and a plurality of third electrodes formed crossing a common direction of the first electrodes and the second electrodes, the method comprising:
biasing the first electrodes at a first voltage during all subfields for driving the plasma display device;
selecting a discharge cell to be turned on during a first subfield by applying to a second electrode during an address period of the first subfield a first scan pulse of a second voltage;
alternately applying to the second electrode during a sustain period of the first subfield a third voltage and a fourth voltage, the fourth voltage being lower than the third voltage;
selecting a discharge cell to be turned off in a second subfield by applying to the second electrode during an address period of the second subfield a second scan pulse of a fifth voltage, the fifth voltage being higher than the second voltage; and
alternately applying to the second electrode during a sustain period of the second subfield a sixth voltage and a seventh voltage, the seventh voltage being higher than the sixth voltage.

2. The driving method of claim 1, wherein a width of the second scan pulse is less than a width of the first scan pulse.

3. The driving method of claim 1, wherein the fifth voltage is higher than the fourth voltage.

4. The driving method of claim 1, further comprising, during a reset period of the first subfield:
applying to the second electrode a voltage gradually increasing to an eighth voltage; and
applying to the second electrode a voltage gradually decreasing to a ninth voltage.

5. The driving method of claim 4, further comprising:
applying to a third electrode in at least a portion of a period while the voltage gradually increasing to the eighth voltage is being applied to the second electrode a tenth voltage, the tenth voltage being higher than the first voltage.

6. The driving method of claim 1, wherein the second subfield is consecutive to the first subfield and the address period of the second subfield is consecutive to the sustain period of the first subfield.

7. The driving method of claim 6, further comprising, during the address period of the second subfield, selecting a discharge cell to be turned off during the second subfield from among discharge cells having undergone sustain discharge during the sustain period of the first subfield.

8. The driving method of claim 1,
wherein magnitudes of the third voltage and the fourth voltage are substantially equal and a phase of the third voltage is a reverse of a phase of the fourth voltage,
wherein magnitudes of the sixth voltage and the seventh voltage are substantially equal and a phase of the sixth voltage is a reverse of a phase of the seventh voltage,
wherein the third voltage and the seventh voltage have substantially equal levels, and
wherein the fourth voltage and the sixth voltage have substantially equal levels.

9. The driving method of claim 1,
wherein during the sustain period of the first subfield, a first sustain discharge pulse applied to the second electrode is of the third voltage, and
wherein during the sustain period of the second subfield, a first sustain discharge pulse applied to the second electrode is of the sixth voltage.

10. The driving method of claim 9, wherein during the sustain period of the first subfield, a last sustain discharge pulse applied to the second electrode is of the third voltage.

11. The driving method of claim 9, wherein during the sustain period of the second subfield, a width of the first sustain discharge pulse applied to the second electrode is greater than a width of at least one of the sustain discharge pulses following the first sustain pulse.

12. A plasma display device comprising:
a plasma display panel having a plurality of first electrodes, a plurality of second electrodes, and a plurality of third electrodes crossing a common direction of the first electrodes and the second electrodes; and
a chassis base facing the plasma display panel and including a driving board for applying a driving waveform to the second and third electrodes for displaying an image on the plasma display panel and for biasing the first electrode to a first voltage while the image is being displayed,
wherein the driving board selects a discharge cell to be turned on during a first subfield by applying to the second electrodes during an address period of the first subfield a first scan pulse having a first width, and
wherein the driving board selects a discharge cell to be turned off during a second subfield by applying to the second electrodes during an address period of the second subfield a second scan pulse having a second width, the second width being less than the first width.

13. The plasma display device of claim 12, wherein a voltage level of the second scan pulse is higher than a voltage level of the first scan pulse.

14. The plasma display device of claim 12,
wherein during a sustain period of the first subfield, the driver board alternately applies to the second electrodes sustain pulses of a second voltage and a third voltage, the third voltage being lower than the second voltage, and
wherein during the sustain period of the second subfield, the driver board alternately applies to the second electrodes sustain pulses of the third voltage and a fourth voltage.

15. The plasma display device of claim 14, wherein the second voltage and the third voltage have substantially equal magnitudes and reverse phases.

16. The plasma display device of claim 14,
wherein during a reset period of the first subfield, the driving board gradually increases a voltage of the second electrode to the second voltage and then gradually decreases the voltage of the second electrode to the third voltage, and
wherein during at least a portion of a period when the voltage of the second electrodes is being gradually increased to the second voltage, the driving board applies to the third electrodes a fifth voltage, the fifth voltage being greater than the first voltage.

17. The plasma display device of claim 12, wherein the second subfield is consecutive to the first subfield and the address period of the second subfield is consecutive to the sustain period of the first subfield.

18. The plasma display device of claim 17, wherein during the address period of the second subfield, a discharge cell to be turned off during the second subfield is selected from among discharge cells having undergone sustain discharge during the sustain period of the first subfield.

19. The plasma display device of claim 14,
wherein a first sustain pulse and a last sustain pulse applied by the driving board to the second electrodes during the sustain period of the first subfield are of the second voltage, and
wherein a first sustain pulse applied by the driving board to the second electrodes during the sustain period of the second subfield is of the third voltage.

20. The plasma display device of claim 12, wherein the first voltage is a ground voltage.
